(19) United States
(12) Patent Application Publication
(10) Pub. No.: US 2025/0007594 A1
(43) Pub. Date: Jan. 2, 2025

(54) BEAM SELECTION ADAPTIVE TO USER EQUIPMENT DISTRIBUTION

(71) Applicant: Nokia Solutions and Networks Oy, Espoo (FI)

(72) Inventors: Yan ZHAO, Shanghai (CN); Hao LIU, Shanghai (CN); Stefan WESEMANN, Kornwestheim (DE); Nuan SONG, Shanghai (CN); Rana AHMED SALEM, Munich (DE); Tao YANG, Shanghai (CN)

(73) Assignee: Nokia Solutions and Networks Oy, Espoo (FI)

(21) Appl. No.: 18/712,460

(22) PCT Filed: Nov. 25, 2021
(86) PCT No.: PCT/CN2021/133090

§ 371 Date: May 22, 2024

(51) Int. Cl. H04B 7/06; H04W 72/044

(52) U.S. Cl. CPC H04B 7/06958; H04W 72/046

(57) ABSTRACT

Various example embodiments relate to devices and methods supporting beam selection adaptive to user equipment distribution. A network device may be configured to sweep a first set of beams predefined for a cell, determine one or more supplement beams for one or more user equipments in the cell, and sweep at least a portion of the one or more supplement beams. The one or more supplement beams are selected from a second set of beams different from the first set of beams.

### TECHNICAL FIELD

Various example embodiments described herein generally relate to communication technologies, and more particularly, to devices and methods supporting beam selection adaptive to user equipment (UE) distribution.

### BACKGROUND

Certain abbreviations that may be found in the description and/or in the figures are herewith defined as follows:
CQI Channel Quality Information
CRI CSI-RS Resource Indicator
CSI Channel State Information
DCI Downlink Control Information
gNB next Generation Node-B
MAC Medium Access Control
MIMO Multiple Input Multiple Output
NR New Radio
PMI Precoding Matrix Indication
RI Rank indication
RRC Radio Resource Control
RS Reference Signal
RSRP Reference Signal Received Power
SRS Sounding Reference Signal
SSB Synchronization Signal Block
UE User Equipment

5G New Radio (NR) has been extended to higher frequencies known as millimeter-wave (mmWave) to support services that require a very high data rate and an ultra-low latency. The mmWave has a small single antenna size and an increased path loss. To compensate for such shortcomings, massive multiple input multiple output (MIMO) and beamforming can be used for the mmWave. The massive MIMO uses dozens or hundreds of individual antenna elements arranged in an array. Phase and amplitude of signals transmitted from multiple antenna elements in the array can be adjusted to induce a constructive effect in a specific direction and a destructive effect in other directions, thereby concentrating the transmitted signals into a target beam in the specific direction.

### SUMMARY

A brief summary of exemplary embodiments is provided below to provide basic understanding of some aspects of various embodiments. It should be noted that this summary is not intended to identify key features of essential elements or define scopes of the embodiments, and its sole purpose is to introduce some concepts in a simplified form as a preamble for a more detailed description provided below.

In a first aspect, an example embodiment of a network device is provided. The network device may comprise at least one processor and at least one memory. The at least one memory includes computer program code stored thereon. The at least one memory and the computer program code may be configured to, with the at least one processor, cause the network device to perform actions including sweeping a first set of beams predefined for a cell, determining one or more supplement beams for one or more user equipments in the cell, and sweeping at least a portion of the one or more supplement beams. The one or more supplement beams are selected from a second set of beams different from the first set of beams.

In a second aspect, an example embodiment of a terminal device is provided. The terminal device may comprise at least one processor and at least one memory. The at least one memory includes computer program code stored thereon. The at least one memory and the computer program code may be configured to, with the at least one processor, cause the terminal device to perform actions including receiving a first resource allocation for a first set of beams, measuring the first set of beams based on the first resource allocation, receiving a second resource allocation for a supplement beam different from the first set of beams, and measuring the supplement beam at a timing different from the timing of measuring the first set of beams, based on the second resource allocation.

Example embodiments of methods, apparatus and computer program products are also provided. Such example embodiments generally correspond to the above example embodiments of the network device and the terminal device, and a repetitive description thereof is omitted here for convenience.

Other features and advantages of the example embodiments of the present disclosure will also be apparent from the following description of specific embodiments when read in conjunction with the accompanying drawings, which illustrate, by way of example, the principles of example embodiments of the present disclosure.

### BRIEF DESCRIPTION OF THE DRAWINGS

Some example embodiments will now be described, by way of non-limiting examples, with reference to the accompanying drawings.

FIG. 1 is a schematic diagram illustrating a cellular communication network in which example embodiments of the present disclosure can be implemented.

FIG. 2 is a schematic diagram illustrating a massive MIMO panel split into subpanels.

FIG. 3 is a schematic diagram illustrating cell coverage of beams transmitted from a massive MIMO panel.

FIG. 4 is a message flow diagram illustrating operations for beam selection and sweeping in accordance with some example embodiments.

FIG. 5 is a flow chart illustrating a method for determining one or more supplement beams for one or more user equipments in accordance with some example embodiments.

FIG. 6 is a flow chart illustrating a method for allocating resources to a predetermined number of supplement beams based on priority of the supplement beams in accordance with some example embodiments.

FIG. 7A is a schematic diagram illustrating an example of sweeping the original and supplement beams in accordance with some example embodiments.

FIG. 7B is a schematic diagram illustrating another example of sweeping the original and supplement beams in accordance with some example embodiments.

FIG. 8 is a functional block diagram illustrating an apparatus implemented at a network device in accordance with some example embodiments.

FIG. 9 is a functional block diagram illustrating an apparatus implemented at a terminal device in accordance with some example embodiments.

FIG. 10 is a structure block diagram illustrating devices in a communication system in which example embodiments of the present disclosure can be implemented.

Throughout the drawings, same or similar reference numbers indicate same or similar elements. A repetitive description on the same elements would be omitted.

### DETAILED DESCRIPTION

Herein below, some example embodiments are described in detail with reference to the accompanying drawings. The following description includes specific details for the purpose of providing a thorough understanding of various concepts. However, it will be apparent to those skilled in the art that these concepts may be practiced without these specific details. In some instances, well known circuits, techniques and components are shown in block diagram form to avoid obscuring the described concepts and features.

As used herein, the term “network device” refers to any suitable entities or devices that can provide cells or coverage, through which the terminal device can access the network or receive services. The network device may be commonly referred to as a base station. The term “base station” used herein can represent a node B (NodeB or NB), an evolved node B (eNodeB or eNB), or a gNB or an ng-eNB. The base station may be embodied as a macro base station, a relay node, or a low power node such as a pico base station or a femto base station. The base station may consist of several distributed network units, such as a central unit (CU), one or more distributed units (DUs), one or more remote radio heads (RRHs) or remote radio units (RRUs). The number and functions of these distributed units depend on the selected split RAN architecture.

As used herein, the term “terminal device” or “user equipment” (UE) refers to any entities or devices that can wirelessly communicate with the network devices or with each other. Examples of the terminal device can include a mobile phone, a mobile terminal, a mobile station, a subscriber station, a portable subscriber station, an access terminal, a computer, a wearable device, an on-vehicle communication device, a machine type communication (MTC) device, a D2D communication device, a V2X communication device, a sensor and the like. The term “terminal device” can be used interchangeably with UE, a user terminal, a mobile terminal, a mobile station, or a wireless device.

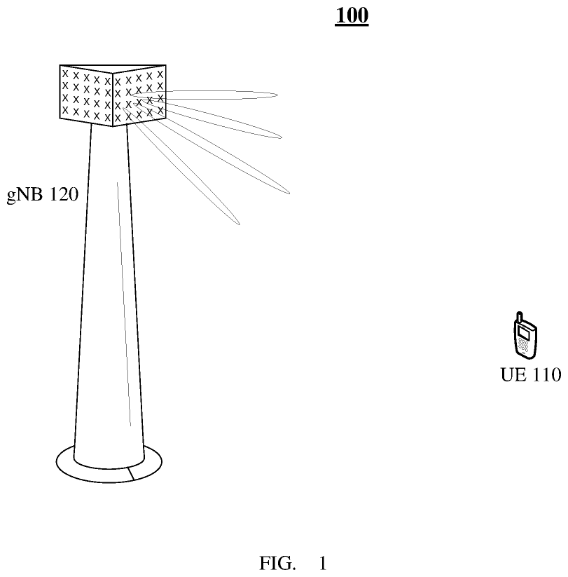

FIG. 1 illustrates a schematic diagram of a cellular communication network 100 in which example embodiments of the present disclosure can be implemented. Referring to FIG. 1, the cellular communication network 100, which may be a part of a larger network or system, may include a base station 120 shown as gNB and one or more user equipments (UEs) 110 (only one is shown) in communication with the base station 120. The base station 120 may include one or more antenna panels in which a number of antenna elements are arranged in an array. The base station 120 can adjust amplitudes and phase shifts of transmit signals provided to the antenna elements so that signals radiated from the antenna array coherently combine together for a particular transmit direction and destructively cancel each other out for other directions, forming an aggregate transmit signal exhibiting beam-like qualities with more power propagating in the particular direction. This is the so-called beamforming. Beamforming can increase cell coverage and it is suitable especially for the millimeter wave frequency range (FR2) which suffers from a high path loss.

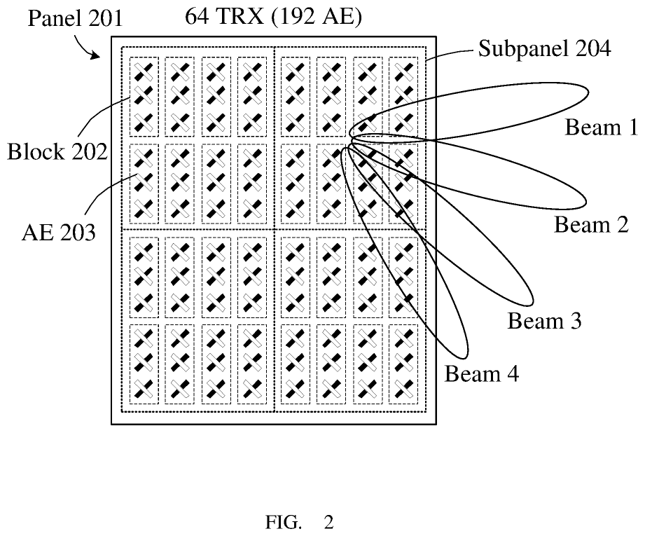

For massive multiple input multiple output (MIMO), the antenna panel may include hundreds of antenna elements. FIG. 2 shows an example of a panel 201, which includes 192 antenna elements (AEs) 203. Referring to FIG. 2, a transceiver block 202 includes 6 antenna elements 203 with X-polarization configuration, in which 3 antenna elements 203 of the same polarization form a transceiver (TRX) unit. As such, the transceiver block 202 represents 2 TRX units, and the panel 201 includes 64 TRX units. It would be understood that the panel 201 for massive MIMO may include more or less TRX units.

One challenge for the panel 201 is that it is infeasible to implement full digital precoding on the whole TRX units (i.e. RF chains) to achieve massive MIMO gain, considering hardware processing complexity and cost, reference signal (RS) measurement and feedback overhead. A technical solution named “split panel” has been proposed to solve this problem. Referring to FIG. 2, the panel 201 may be divided into 2 equal parts in the horizontal direction and 2 equal parts in the vertical direction, thereby forming 4 subpanels 204 each containing 16 TRX units. It would be understood that the panel 201 may be split in other ways. For example, the subpanel 204 may include more or less TRX units. The 16 TRX units in the subpanel 204 may be mapped to 2 virtual ports (VPs) which correspond to two polarizations respectively, and each VP includes 8 TRX units of the same polarization. Instead of the TRX units (i.e. RF chains), the VPs serve as a minimal unit mapping into antenna ports, and the digital precoding may be performed based on the VPs. By adjusting size (i.e. the number of TRX units in a VP) and shape of the VPs, different kinds of VP mapping can be obtained. The split panel and VP mapping technology can reduce the number of ports for baseband processing and improve multiple-user scheduling performance.

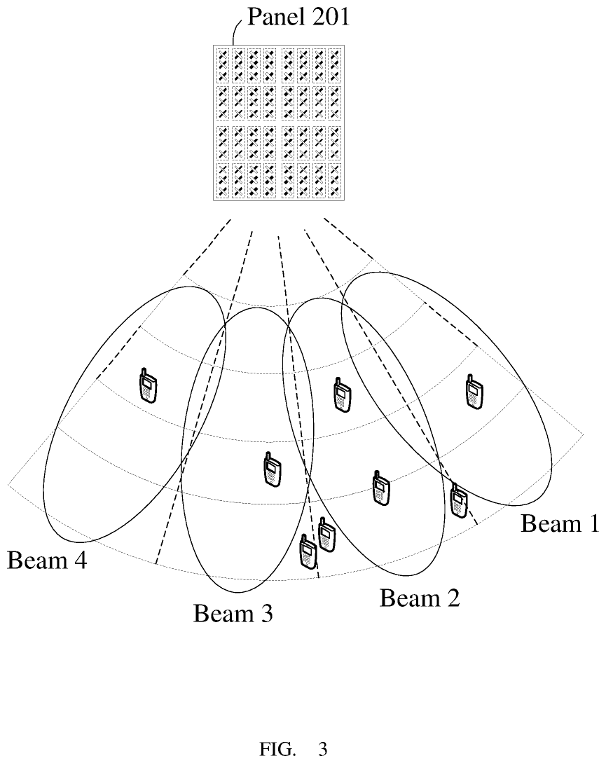

With continuous reference to FIG. 2, each subpanel 204 may generate a predetermined number of beams to cover a cell. For example, FIG. 2 shows 4 beams, and 4 CSI-RS resources are needed to transmit the 4 beams at the same time. Considering the 4 subpanels 204 and the X polarization configuration, each CSI-RS resource has eight ports. However, a problem is that the 4 beams have a constant direction, and they cannot adapt to UE distribution in the cell. For example, as shown in FIG. 3, the 4 beams cannot effectively serve the UEs moving to the beam edge. If more beams are predefined for the cell to enhance coverage at the beam edge, processing complexity and resource overhead would increase while beam efficiency becomes worse. For example, it is possible that the base station 120 keeps sweeping a certain beam while no UE is covered/served by the beam.

Some solutions have been proposed to overcome this problem by replacing the 4 original beams predefined for a cell with new beams adaptive to UE distribution in the cell. For example, the UEs in the cell may be divided into 4 groups based on spatial correlation of UE channels, and then an adaptive CRI beam may be individually calculated for each group based on channel statistical characteristics of UEs in the group. However, this scheme needs high computation coast. In another example, the gNB 120 may select 4 CRI beams from a set of predefined CRI beams based on UE SRS measurement and UE CSI report. With the same split panel, this scheme needs to combine each CRI beam and UE PMI feedback for the choice of CRI beam to obtain average beamforming gain for all UEs for the strongest layer. Finally, this scheme gets a four-CRI-beams combination with maximal average beamforming gain. However, this scheme spends a lot of time and resources on sweeping all CRI beams and getting UE PMI feedback. In addition, the above two schemes cannot guarantee to serve the edge UEs better than the 4 original beams do.

Hereinafter, various example embodiments of devices and methods supporting an efficient scheme of beam selection will be described in detail with reference to the accompanying drawings. In the example embodiments, beam selection may be performed adaptive to UE distribution from a group of extra beams as supplements to the original beams. It is an enhancement of the original beam scheme so as to obtain a better coverage, not to replace the original beams. Compared to the schemes of replacing the original beams, the proposed beam selection scheme can adapt to UE distribution faster with little CRI level computation overhead as the original beams are used and the scheme needs only to select the supplement beams for UEs that are not effectively served by the original beams. The proposed beam selection scheme also achieves a significant performance gain. It would be appreciated that the proposed beam selection scheme is applicable not only to the split panel scenario but also to non-split panel scenarios.

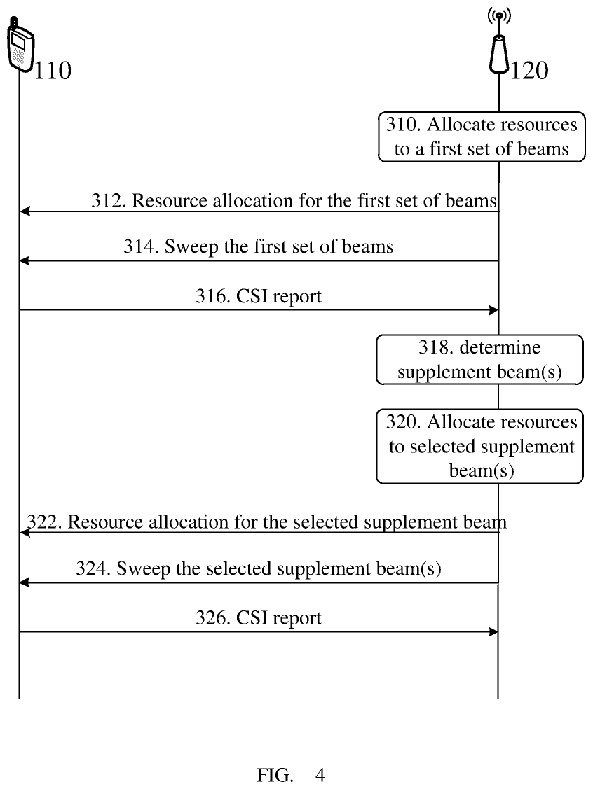

FIG. 4 is a message flow diagram illustrating operations for beam selection and beam sweeping in accordance with some example embodiments. The operations shown in FIG. 4 may be performed by a user equipment and a base station, for example the UE 110 and the base station 120 described above with respect to FIG. 1.

Referring to FIG. 4, at 310, the base station 120 may allocate resources to a first set of beams. The first set of beams may be referred to as original beams or cell-specific beams, which are predefined at the base station 120 for a cell. For example, when the network operator deploys the base station 120, the operator may predefine a predetermined number of original beams for a cell in consideration of for example geographic area of the cell, general UE distribution in the cell, buildings, roads and parks in the cell and/or other factors. The operator may also update the predefined original beams for example when buildings or roads change in the cell. The number and coverage of the original beams may be optimized to achieve high beam efficiency, sufficient cell coverage and good network performance. In some example embodiments, the first set of original beams may include 4 beams, though more or less original beams may also be used. The base station 120 does not need to determine/optimize the original beams for the cell frequently, which would reduce computation cost at the base station 120. At the operation 310, the base station 120 may allocate periodic CSI-RS resources for the original beams. For example, when the first set of original beams include 4 beams, the base station 120 may allocate 4 periodic CSI-RS resources to the 4 original beams, respectively. In some example embodiments, the base station 120 may also allocate, in the operation 310 or in a separate operation, uplink resources for the UE 110 to report CSI in response to receiving and measuring the original beams. The base station 120 may schedule periodic or aperiodic/dynamic CSI report for the UE 110.

At 312, the base station 120 may notify the UE 110 of the resource allocation for the first set of original beams. For example, the base station 120 may send the resource allocation notification to UEs in the cell via RRC signaling such as csi-ResourceConfig, or via master information block (MIB), system information block (SIB), medium access control element (MAC CE) or downlink control information (DCI). Based on the resource allocation notification, the UE 110 can attempt to receive and measure all of the original beams. In some example embodiments, the base station 120 may also notify the UE 110 of the uplink resources for reporting CSI. For example, the base station 120 may indicate to the UE 110 of the uplink resources for CSI report via RRC signaling such as csi-ReportConfig, or via MIB, SIB, MAC CE or DCI.

Then at 314, the base station 120 may sweep the first set of original beams on the allocated resources. The base station 120 may transmit a downlink reference signal such as CSI-RS on each of the original beams. The UE 110 may measure the CSI-RSs based on the received resource allocation and determine the best beam for itself. In some example embodiments, the UE 110 may determine the best beam by measuring reference signal received power (RSRP), reference signal received quality (RSRQ) and/or signal to interference plus noise ratio (SINR) of the CSI-RS.

At 316, the UE 110 may send a CSI report to the base station 120. The CSI report may include, as the best beam ID, a CSI-RS resource indicator (CRI) where the best beam (CSI-RS) is located. Optionally, the CSI report may also include one or more of RSRP, precoding matrix indicator (PMI), channel quality information (CQI), rank indicator (RI) or the like obtained by measuring the best beam.

As mentioned above with respect to FIG. 3, the original beams may not effectively serve one or more UEs moving to the beam edge. To address this issue, in some example embodiments, the base station 120 may further determine at 318 one or more supplement beams to serve one or more UEs that cannot get quality service from the original beams. The supplement beams may be selected from a second set of beams that are different from the first set of original beams. The second set of supplement beams may be generated by for example oversampling DFT (discrete Flurier transform) beams, rotation of the original beams, using a group of Eigen beams or other methods. The second set of supplement beams may be designed to compensate for coverage at edge of the original beams. The base station 120 can select one or more supplement beams from the second set of beams according to for example distribution of active UEs in the cell, which will be described below in detail.

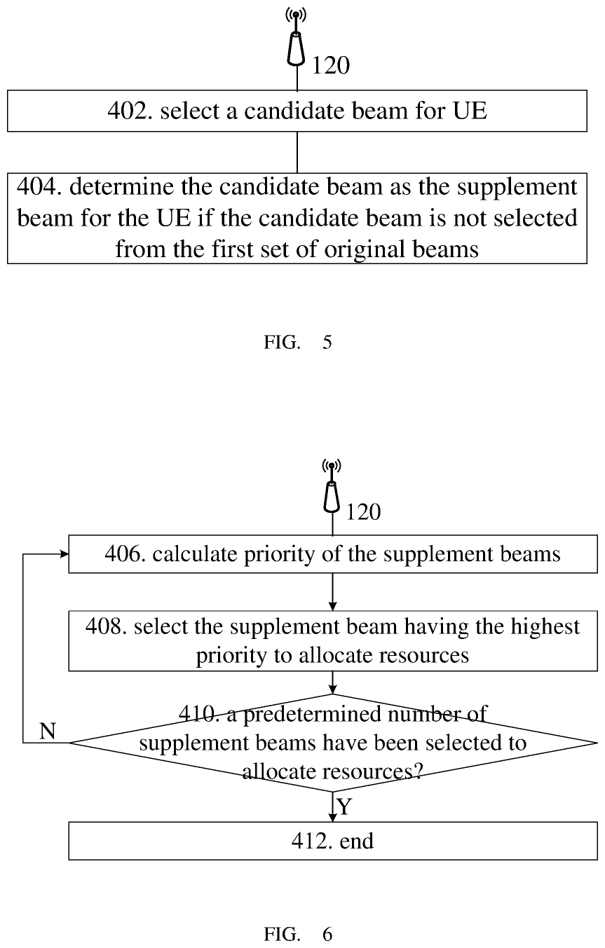

FIG. 5 illustrates a flow chart of a method for determining one or more supplement beams for one or more UEs in accordance with some example embodiments. Referring to FIG. 5, at 402, the base station 120 may select a candidate beam for the UE 110. The candidate beam may be selected from the first set of original beams and the second set of supplement beams. In some example embodiments, the base station 120 may take advantage of UL/DL reciprocity for a time division duplexing (TDD) system or UL/DL reciprocity compensation for a frequency division duplexing (FDD) system to obtain UE equivalent downlink channel and then select a candidate beam with the highest correlation with the equivalent downlink channel from the first set of original beams and the second set of supplement beams. In some example embodiments, the base station 120 may select a candidate beam having the highest correlation with the synchronization signal block (SSB) index identified by the UE 110. It would be appreciated that the base station 120 may select the same candidate beam for a plurality of UEs for example when the plurality of UEs are located at the same zone.

If the candidate beam is selected from the first set of original beams, the base station 120 determines that the original beam, as the best beam for the UE 110, can serve the UE 110 effectively and it does not need to choose a supplement beam for the UE 110. If the candidate beam is selected from the second set of supplement beams, the base station 120 determines at 404 that the first set of original beams cannot serve the UE 110 effectively and the selected candidate/supplement beam would be used for the UE 110. It would be appreciated that depending on UE distribution in the cell, the base station 120 may determine one or more supplement beams for one or more UEs, and multiple UEs may possibly share the same supplement beam. In this way, the base station 120 can determine the supplement beams adaptive to UE distribution fast and it does not need high computation or resource overhead.

Referring back to FIG. 4, at 320, the base station 120 may allocate resources to at least a portion of the selected supplement beams. To save resources for data transmission and ensure beam efficiency, the base station 120 may allocate resources to a predetermined/threshold number of supplement beams. If the number of supplement beams determined at the operation 404 is less than or equal to the threshold, the base station 120 may allocate resources to all of the supplement beams determined at the operation 404. If the number of supplement beams determined at the operation 404 is larger than the threshold, the base station 120 may allocate resources to the threshold number of supplement beams based on priority of the selected supplement beams.

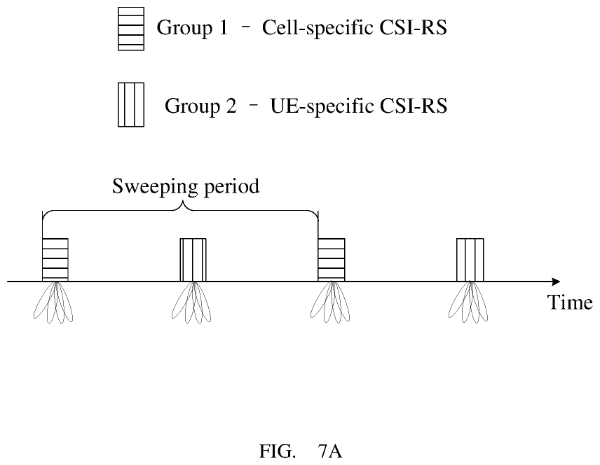

FIG. 6 illustrates a flow chart of a method for allocating resources to a predetermined/threshold number of supplement beams based on priority of the supplement beams in accordance with some example embodiments. Referring to FIG. 6, at 406, the base station 120 may calculate priority of the supplement beams selected at the operation 404. The priority of the supplement beams may be in proportion to the number of UEs corresponding the supplement beam and in inverse proportion to correlation between the supplement beam and one or more beams with allocated resources. The one or more beams with allocated resources may include at least the first set of original beams, or further include one or more supplement beams that have been allocated with resources. In some example embodiments, the base station 120 may calculate the priority of the supplement beams based on the below Equation (1). In the Equation (1), i and j are beam indexes, D represents the set of supplement beams that are determined at the operation 404 but have not been allocated with resources, S represents the set of beams with allocated resources including the original beams and possibly one or more supplement beams, UE_Numᵢ is the number of UEs covered by the i^{th} supplement beam in the set D, CCM_{i,j} is a correlation coefficient matrix (CCM) between the i^{th} supplement beam in the set D and the j^{th} beam in the set S, and Beam_Priorityᵢ is the priority of the i^{th} supplement beam in the set D.

$${Beam\_Priority}_{i} = {UE\_Num}_{i} / ( 1 + {\sum }_{j} ( C C {M}_{i , j} ) ) , i ∈ \{ D \} , j ∈ \{ S \} \qquad ( 1 )$$

It would be appreciated that at the beginning, no supplement beam is allocated with resources. That is, all the supplement beams determined at the operation 404 belongs to the set D and the set S includes only the first set of original beams. The base station 120 calculates the priority of the supplement beams in the set D at the operation 406.

At 408, the base station 120 may select a first supplement beam that has the highest priority from the set D to allocate resources. The operation may be represented by the below Equation (2). In the Equation (2), argmax( ) is a function that returns the index i of the supplement beam in the set D having the highest priority. When the first supplement beam with the highest priority is selected to allocate resources in the operation 408, the first supplement beam would be moved from the set D to the set S and then the set S includes the first set of original beams and the first supplement beam.

$${Beam}_{Highest Priority} = {arg max}_{i ∈ \{ D \}} ( {Beam\_Priority}_{i} ) \qquad ( 2 )$$

At 410, the base station 120 determines if a predetermined number of supplement beams have been selected to allocate resources. If the number of the supplement beams with allocated resources is less than the predetermined number, the base station 120 may iteratively perform the calculation operation 406 and the selection operation 408 until the predetermined number of supplement beams have been allocated with resources. Here “iterative” means that when one supplement beam is selected from the set D to allocate resources, the selected supplement beam would be moved from the set D of supplement beams not allocated with resources to the set S of beams with allocated resources for the next round of priority calculation and highest priority beam selection. The base station 120 would calculate priority of the remaining supplement beams not allocated with resources and select the supplement beam with the highest priority to allocate resources. When the number of the supplement beams with allocated resources is equal to the predetermined number, the method ends at 412. Since the base station 120 allocates resources only to the predetermined number of selected supplement beams, resource overhead can be reduced.

In some example embodiments, the base station 120 may not allocate resources to a supplement beam for a certain UE for example when more than the predetermined number of supplement beams are determined at the operation 404 and the supplement beam for the certain UE has a lower priority. In this case, the base station 120 can still select the best beam for the UE from the beams that have been allocated with resources, including the first set of original beams and the predetermined number of supplement beams. If the best beam is selected from the predetermined number of supplement beams, the base station 120 would also notify the UE of the resource allocation for the selected best supplement beam in a subsequent operation.

Referring back to FIG. 4, in some example embodiments, the resources allocated to the supplement beams at the operation 320 may be different at least in the time domain from the resources allocated to the original beams at the operation 310 so that the original beams and the supplement beams would be swept at different time. In some example embodiments, the base station 120 may also allocate at the operation 320 uplink resources for the UE 110 to report CSI in response to receiving and measuring the supplement beam. The base station 120 may schedule periodic or aperiodic/dynamic CSI report for the UE 110.

At 322, the base station 120 may notify the UE 110 of the resource allocation for the supplement beam. For example, the base station 120 may send the resource allocation notification to the UE 110 via RRC signaling, MIB, SIB, MAC CE or DCI. Unlike the operation 312 where the base station 120 notify the resource allocation for the original beams to all UEs in the cell, in the operation 322 the base station 120 may notify the resource allocation for the supplement beam only to one or more UEs that are served by the supplement beam. That is, the original beams have cell-specific resources, while the supplement beams have UE-specific resources. In some example embodiments, the base station 120 may also notify the UE 110 of the uplink resources for reporting CSI in response to receiving and measuring the supplement beam. For example, the base station 120 may indicate to the UE 110 of the uplink resources for CSI report via RRC signaling, MIB, SIB, MAC CE or DCI.

Then at 324, the base station 120 may sweep the supplement beams using the allocated resources. The base station 120 may transmit a downlink reference signal such as CSI-RS on each of the supplement beams. The UE 110 may measure the CSI-RS based on the received resource allocation at 324 and send a CSI report to the base station 120 at 326. It would be appreciated that a UE would measure one supplement beam if it receives the resources allocated to the supplement beam or it would not measure any supplement beam if it does not receive the resource allocation for the supplement beam. The CSI report may include CRI where the supplement beam is located and one or more of RSRP, PMI, CQI, RI or the like obtained by measuring the supplement beam. Based on the CSI report received in the operation 316 and the CSI report received in the operation 326, the base station 120 would select a beam for communication with the UE 110.

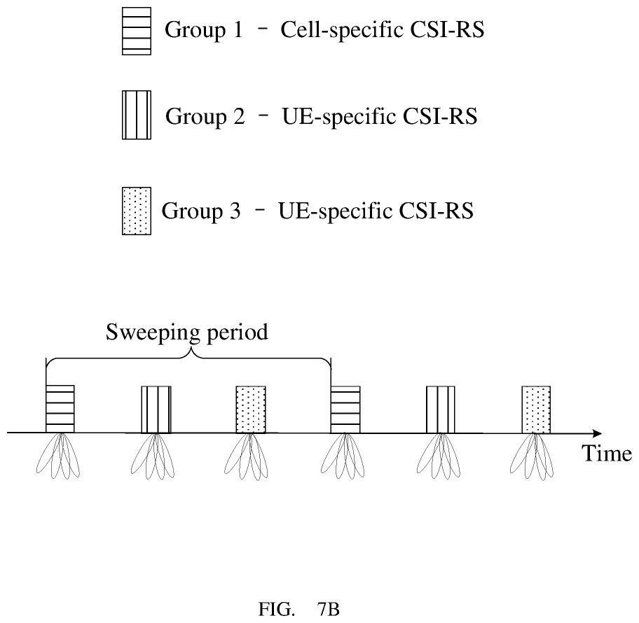

FIGS. 7A and 7B are schematic diagrams illustrating examples of sweeping the original beams and the supplement beams in accordance with some example embodiments. Referring to FIG. 7A, the first group of original beams are periodically swept using cell-specific CSI-RS resources, and the second group of supplement beams are periodically swept using UE-specific CSI-RS resources. The original beams and the supplement beams may be swept at the same period with a timing difference between the sweeping of the original beams and the sweeping of the supplement beams. The timing difference may be about a half of the sweeping period. In the example shown in FIG. 7A, the number of supplement beams is equal to the number of original beams. Compared to a case where only the original beams are swept at a period half of the period for sweeping both the original beams and the supplement beams, the supplement beams may re-use the reserved resources for the original beams and the total CSI-RS resource consumption for beam sweeping is not increased. When the number of the supplement beams is less than the number of the original beams, the reserved resources not allocated to CSI-RS may be used for data transmissions.

FIG. 7B shows a case where the number of the supplement beams is larger than the number of the original beams. As shown in FIG. 7B, the supplement beams may be divided into multiple groups (Group 2 and Group 3 as shown) such that the number of the supplement beams in each group is less than or equal to the number of the original beams. The first group of the original beams, the second group of the supplement beams and the third group of the supplement beams may be swept at different time so that four CSI-RS resources may be re-used for sweeping the original beams and the supplement beams.

Referring to FIGS. 7A and 7B, it would be appreciated that as UEs move in the cell, the supplement beams needed for UEs at edge of the original beams may change. The base station 120 may periodically perform operations in FIGS. 5-6 to select the supplement beams for UEs at edge of the original beams and allocate resources to at least a portion of the supplement beams. The periodicity of determining and allocating resources to the supplement beams may be longer than or equal to the periodicity of sweeping the supplement beams.

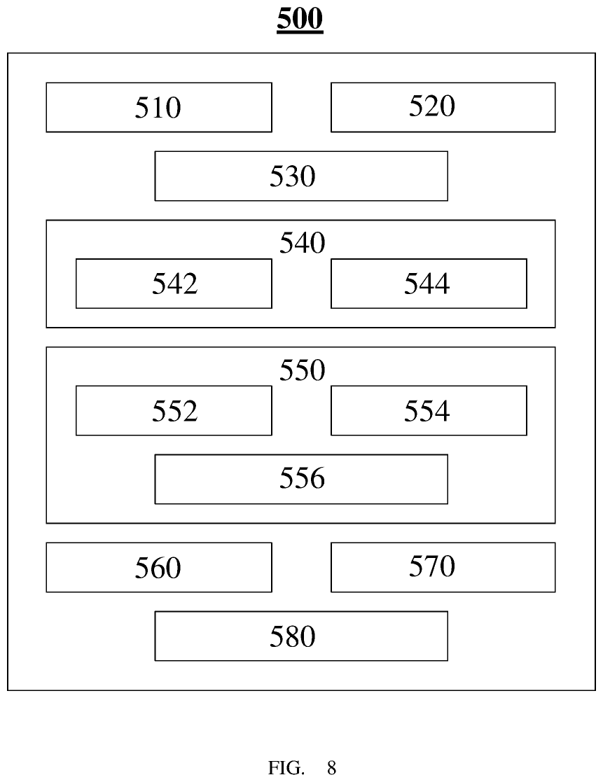

FIG. 8 is a functional block diagram illustrating an apparatus 500 implemented at a network device such as the base station 120 in accordance with some example embodiments. Referring to FIG. 8, the apparatus 500 may include a first means 510 for allocating resources to a first set of original beams predefined for a cell, a second means 520 for sweeping the first set of original beams using the allocated resources, and a third means 530 for receiving CSI reports transmitted from UEs in response to receiving and measuring the first set of original beams.

The apparatus 500 may further include a fourth means 540 for determining one or more supplement beams for one or more UEs in the cell. The one or more supplement beams are selected from a second set of beams different from the first set of original beams. In some example embodiments, the fourth means 540 may include a first sub-means 542 for selecting a candidate beam for a UE from the first set of original beams and the second set of beams, and a second sub-means 544 for determining the candidate beam as the supplement beam for the UE when the candidate beam is not selected from the first set of original beams.

The apparatus 500 may further include a fifth means 550 for allocating resources to at least a portion of the one or more supplement beams. For example, the fifth means 550 may allocate resources to the supplement beams based on priority of the supplement beams. In some example embodiments, the fifth means 550 may include a first sub-means 552 for calculating the priority of the one or more supplement beams, and a second sub-means 554 for selecting a supplement beam with the highest priority to allocate resources. The priority of the supplement beams may be in proportion to the number of UEs corresponding to the supplement beam and in inverse proportion to correlation between the supplement beam and one or more beams with allocated resources. The one or more beams with allocated resources may include the first set of original beams and possibly one or more supplement beams that have been allocated with resources. The fifth means 550 may further include a third sub-means 556 for determining if a predetermined number of supplement beams have been allocated with resources. If the number of the supplement beams with allocated resources is less than the predetermined number, the first sub-means 552 and the second sub-means 554 may iteratively perform the priority calculation operation and the resource allocation operation until the predetermined number of supplement beams have been allocated with resources.

The apparatus 500 may further include a sixth means 560 for notifying the resource allocation for the supplement beams to UEs associated with the supplement beams, a seventh means 570 for sweeping the supplement beams based on the resource allocation for the supplement beams, and an eighth means 580 for receiving CSI reports transmitted from UEs in response to receiving and measuring the supplement beams. Unlike the resource allocation for the first set of original beams that is notified to all UEs in the cell, the resource allocation for a supplement beam may be notified only to one or more UEs that are correlated to the supplement beam. That is, the UE needs to measure at most one supplement beam.

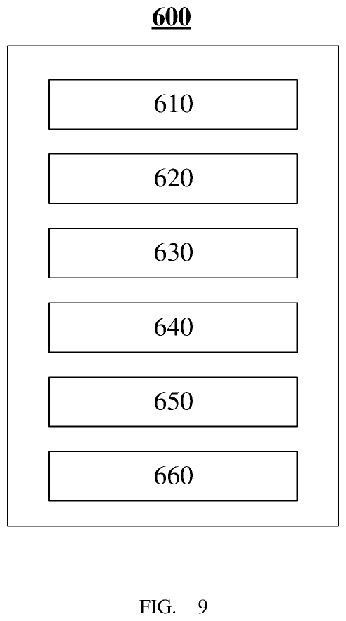

FIG. 9 is a functional block diagram illustrating an apparatus 600 implemented at a terminal device such as the UE 110 in accordance with some example embodiments. Referring to FIG. 9, the apparatus 600 may include a first means 610 for receiving a first resource allocation for a first set of original beams, a second means 620 for measuring the first set of beams based on the received first resource allocation, and a third means 630 for transmitting a CSI report in response to measurement of the first set of original beams.

The apparatus 600 may further include a fourth means 640 for receiving a second resource allocation for a supplement beam different from the first set of original beams, a fifth means 650 for measuring the supplement beam based on the received second resource allocation, and a sixth means 660 for transmitting a CSI report in response to measurement of the supplement beam.

Simulation has been made to evaluate performance of the example embodiments of the present disclosure. The below Table 1 shows basic system assumption for the simulation.

TABLE 1
Basic Simulation Assumption

| Parameter | Assumption |
|---|---|
| Cell layout | 21 cells in NR UMi (Urban Micro) scenario, |
| | ISD (intersection sight distance) 200 m, |
| | average 10 UEs per cell |
| Carrier frequency | FDD - UL/DL: 1.75/2.15 GHZ |
| Bandwidth | 20 MHZ |
| Base station antenna | 192 AEs (12*8*2) |
| | 64 ports (4*8*2) |
| UE antenna | 2 AEs/ports (1*1*2) |
| Tx power | 33 dBm |
| Down tilt | 96 degree in independent TRX |
| Channel model | Sub-6 GHZ in 3GPP TR 38.901 |
| Scheduling algorithm | Proportional-Fair (PF) |
| Traffic | Full buffer |
| UE velocity | 3 km/h for indoor; 30 km/h for outdoor |
| UE distribution | General building 4/8 floors, 80% indoor; 20% |
| | outdoor |
| UL-DL Compensation | gDoA (general Direction of Arrival) |
| | (DDoA, Dominant Direction of Arrival) |
| Codebook | 3GPP 5G/NR Type 1 |
| MU-MIMO | Max UE number {4}, rank adaptation {1, 2} |

The simulation is performed on the below examples:

Comparative Example 1: This example uses a 1*4 beam set (the number of vertical beams*the number of horizontal beams) as the original beam set, and the beams are configured as cell-specific periodic CSI-RS resources for transmission with 40 ms periodicity.

Example 2: This example uses the 1*4 original beam set and a 2*8 supplement beam set. It has two groups of CSI-RS resources: Group 1 for the original cell-specific CSI-RSs and Group 2 for the UE-specific supplement CSI-RSs, as shown in FIG. 7A. The sweeping period is extended from 40 ms to 80 ms so that the CSI-RS overhead is the same as the Comparative Example 1.

Example 3: This example supports up to 8 UE-specific supplement CSI-RSs by adding Group 3 in the 80 ms sweeping period, as shown in FIG. 7B. This example needs extra 50% CSI-RS resources compared to the Comparative Example 1 and the Example 2.

Band utilization (in unit of bps/Hz) of the three examples are simulated and the simulation results are shown in the below Table 2. As shown in the Table 2, compared to the Comparative Example 1, the Example 2 can achieve 16% gain on the cell average, 17% gain on the UE geometric average, and 50% gain on the edge UEs. The Example 3 can achieve 20% gain on the cell average, 27% gain on the UE geometric average, and 97% gain on the edge UEs. The high performance of the example embodiments benefits not only from the better coverage with more beams, but also from the flexible and fast adaption to UE distribution, especially to time-related UE distribution at e.g. supermarkets, office building, residential areas, parks and other areas.

TABLE 2
Simulation Results

| Scheme | Cell Mean | | UE GeoMean | | Edge UE | |
|---|---|---|---|---|---|---|
| (Abs-value: | Absolute | Relative | Absolute | Relative | Absolute | Relative |
| bps/Hz) | value | value | value | value | value | value |
| Comparative | 6.838 | 1 | 0.5015 | 1 | 0.1034 | 1 |
| Example 1 | | | | | | |
| Example 2 | 7.928 | +16% | 0.5866 | +17% | 0.1555 | +50% |
| Example 3 | 8.225 | +20% | 0.6373 | +27% | 0.2037 | +97% |

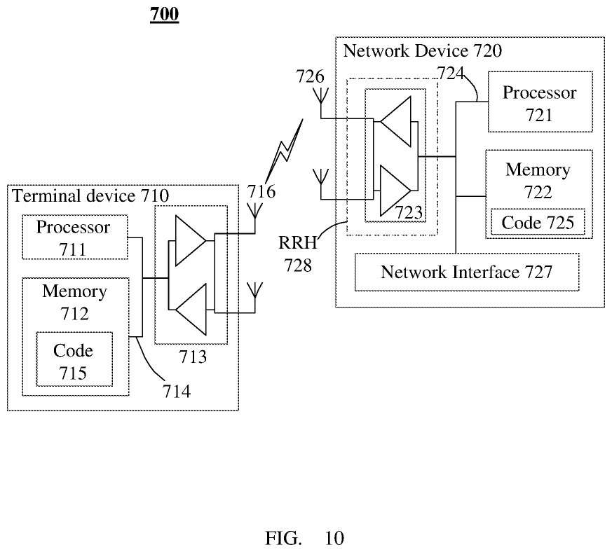

FIG. 10 is a schematic block diagram illustrating devices in a communication system 700 for implementing one or more example embodiments. As shown in FIG. 10, the communication system 700 may comprise a terminal device 710 which may be implemented as the UE 110 discussed above and a network device 720 which may be implemented as the base station 120 discussed above.

Referring to FIG. 10, the terminal device 710 may comprise one or more processors 711, one or more memories 712 and one or more transceivers 713 interconnected through one or more buses 714. The one or more buses 714 may be address, data, or control buses, and may include any interconnection mechanism such as series of lines on a motherboard or integrated circuit, fiber, optics or other optical communication equipment, and the like. Each of the one or more transceivers 713 may comprise a receiver and a transmitter, which are connected to one or more antennas 716. The terminal device 710 may wirelessly communicate with the network device 720 through the one or more antennas 716. The one or more memories 712 may include computer program code 715. The one or more memories 712 and the computer program code 715 may be configured to, when executed by the one or more processors 711, cause the terminal device 710 to perform processes and steps relating to the UE 110 as described above.

The network device 720 may comprise one or more processors 721, one or more memories 722, one or more transceivers 723 and one or more network interfaces 727 interconnected through one or more buses 724. The one or more buses 724 may be address, data, or control buses, and may include any interconnection mechanism such as a series of lines on a motherboard or integrated circuit, fiber, optics or other optical communication equipment, and the like. Each of the one or more transceivers 723 may comprise a receiver and a transmitter, which are connected to one or more antennas 726. The network device 720 may wirelessly communicate with the terminal device 710 through the one or more antennas 726. The one or more transceivers 723 and the one or more antennas 726 may be implemented as one or more remote radio heads (RRHs) 728. The one or more RRHs 728 may be collocated or located at different positions. The one or more buses 724 could be implemented in part as fiber optic cable to connect the RRHs 728 to other components of the network device 720. The one or more network interfaces 727 may provide wired or wireless communication links through which the network device 720 may communicate with other network devices, entities, elements or functions. The one or more memories 722 may include computer program code 725. The one or more memories 722 and the computer program code 725 may be configured to, when executed by the one or more processors 721, cause the network device 720 to perform processes and steps relating to the base station 120 as described above.

The one or more processors 711, 721 and 731 discussed above may be of any appropriate type that is suitable for the local technical network, and may include one or more of general purpose processors, special purpose processor, microprocessors, a digital signal processor (DSP), one or more processors in a processor based multi-core processor architecture, as well as dedicated processors such as those developed based on Field Programmable Gate Array (FPGA) and Application Specific Integrated Circuit (ASIC). The one or more processors 711, 721 and 731 may be configured to control other elements of the UE/network device/network element and operate in cooperation with them to implement the procedures discussed above.

The one or more memories 712, 722 and 732 may include at least one storage medium in various forms, such as a volatile memory and/or a non-volatile memory. The volatile memory may include but not limited to for example a random access memory (RAM) or a cache. The non-volatile memory may include but not limited to for example a read only memory (ROM), a hard disk, a flash memory, and the like. Further, the one or more memories 712, 722 and 732 may include but not limited to an electric, a magnetic, an optical, an electromagnetic, an infrared, or a semiconductor system, apparatus, or device or any combination of the above.

It would be understood that blocks in the drawings may be implemented in various manners, including software, hardware, firmware, or any combination thereof. In some embodiments, one or more blocks may be implemented using software and/or firmware, for example, machine-executable instructions stored in the storage medium. In addition to or instead of machine-executable instructions, parts or all of the blocks in the drawings may be implemented, at least in part, by one or more hardware logic components. For example, and without limitation, illustrative types of hardware logic components that can be used include Field-Programmable Gate Arrays (FPGAs), Application-Specific Integrated Circuits (ASICs), Application-Specific Standard Products (ASSPs), System-on-Chip systems (SOCs), Complex Programmable Logic Devices (CPLDs), etc.

Some exemplary embodiments further provide computer program code or instructions which, when executed by one or more processors, may cause a device or apparatus to perform the procedures described above. The computer program code for carrying out procedures of the exemplary embodiments may be written in any combination of one or more programming languages. The computer program code may be provided to one or more processors or controllers of a general purpose computer, special purpose computer, or other programmable data processing apparatus, such that the program code, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

Some exemplary embodiments further provide a computer program product or a computer readable medium having the computer program code or instructions stored therein. The computer readable medium may be any tangible medium that may contain, or store a program for use by or in connection with an instruction execution system, apparatus, or device. The machine readable medium may be a machine readable signal medium or a machine readable storage medium. A machine readable medium may include but is not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the subject matter has been described in a language that is specific to structural features and/or method actions, it is to be understood the subject matter defined in the appended claims is not limited to the specific features or actions described above. On the contrary, the above-described specific features and actions are disclosed as an example of implementing the claims.

1. A network device comprising:
at least one processor; and
at least one memory including computer program code, the at least one memory and the computer program code being configured to, with the at least one processor, cause the network device to perform:
sweeping a first set of beams, the first set of beams being predefined for a cell;
determining one or more supplement beams for one or more user equipments in the cell, the one or more supplement beams being selected from a second set of beams different from the first set of beams; and
sweeping at least a portion of the one or more supplement beams.

2. The network device of claim 1 wherein the at least a portion of the one or more supplement beams is swept at a timing different from the timing for sweeping the first set of beams.

3. The network device of claim 1 wherein determining one or more supplement beams for one or more user equipments comprises:
selecting a candidate beam for a user equipment from the first set of beams and a second set of beams different from the first set of beams; and
determining the candidate beam as the supplement beam for the user equipment when the candidate beam is selected from the second set of beams.

4. The network device of claim 1 wherein the at least one memory and the computer program code are further configured to, with the at least one processor, cause the network device to perform:
allocating resources to the at least a portion of the one or more supplement beams based on priority of the one or more supplement beams,
wherein the at least a portion of the one or more supplement beams is swept using the allocated resources.

5. The network device of claim 4 wherein the priority of the one or more supplement beams is in proportion to the number of user equipments corresponding to the supplement beam and in inverse proportion to correlation between the supplement beam and one or more beams with allocated resources, the one or more beams with allocated resources including the first set of beams or both the first set of beams and one or more supplement beams selected to allocate resources.

6. The network device of claim 5 wherein allocating resources to the at least a portion of the one or more supplement beams based on priority of the one or more supplement beams comprises:
calculating the priority of the one or more supplement beams based on the number of user equipments corresponding to the supplement beam and the correlation between the supplement beam and the one or more beams with allocated resources;
selecting a first supplement beam that has the highest priority from the one or more supplement beams to allocate resources; and
iteratively repeating the calculating and selecting steps until a predetermined number of supplement beams have been selected to allocate resources.

7. The network device of claim 1 wherein the number of supplement beams included in the at least a portion of the one or more supplement beams is less than or equal to the number of beams included in the first set of beams, or
when the number of supplement beams included in the at least a portion of the one or more supplement beams is larger than the number of beams included in the first set of beams, the at least a portion of the one or more supplement beams is divided into supplement beam groups including a number of supplement beams less than or equal to the number of beams included in the first set of beams, and the supplement beam groups are swept at different timing.

8. The network device of claim 1 wherein the first set of beams and the at least a portion of the one or more supplement beams are swept at an interval of a first period with a time difference between the sweeping of the first set of beams and the sweeping of the at least a portion of the one or more supplement beams, and the one or more supplement beams are determined at an interval of a second period longer than or equal to the first period.

9. A terminal device comprising:
at least one processor; and
at least one memory including computer program code, the at least one memory and the computer program code being configured to, with the at least one processor, cause the terminal device to perform:
receiving a first resource allocation for a first set of beams;
measuring the first set of beams based on the first resource allocation;
receiving a second resource allocation for a supplement beam different from the first set of beams; and
measuring the supplement beam at a timing different from the timing of measuring the first set of beams, based on the second resource allocation.

10. The terminal device of claim 9 wherein the first set of beams and the supplement beam are measured at a first period with a time difference between measurement of the first set of beams and measurement of the supplement beam, and the second resource allocation is received at a second period longer than or equal to the first period.

11. A beam selection method comprising:
sweeping a first set of beams, the first set of beams being predefined for a cell;
determining one or more supplement beams for one or more user equipments in the cell, the one or more supplement beams being selected from a second set of beams different from the first set of beams; and
sweeping at least a portion of the one or more supplement beams.

12. The method of claim 11 wherein the at least a portion of the one or more supplement beams is swept at a timing different from the timing for sweeping the first set of beams.

13. The method of claim 11 wherein determining one or more supplement beams for one or more user equipments comprises:
selecting a candidate beam for a user equipment from the first set of beams and a second set of beams different from the first set of beams; and
determining the candidate beam as the supplement beam for the user equipment when the candidate beam is selected from the second set of beams.

14. The method of claim 11 wherein the at least one memory and the computer program code are further configured to, with the at least one processor, cause the network device to perform:
allocating resources to the at least a portion of the one or more supplement beams based on priority of the one or more supplement beams,
wherein the at least a portion of the one or more supplement beams is swept using the allocated resources.

15. The method of claim 14 wherein the priority of the one or more supplement beams is in proportion to the number of user equipments corresponding to the supplement beam and in inverse proportion to correlation between the supplement beam and one or more beams with allocated resources, the one or more beams with allocated resources including the first set of beams or both the first set of claims and one or more supplement beams selected to allocate resources.

16. The method of claim 15 wherein allocating resources to the at least a portion of the one or more supplement beams based on priority of the one or more supplement beams comprises:
calculating the priority of the one or more supplement beams based on the number of user equipments corresponding to the supplement beam and the correlation between the supplement beam and the one or more beams with allocated resources;
selecting a first supplement beam that has the highest priority from the one or more supplement beams to allocate resources; and
iteratively repeating the calculating and selecting steps until a predetermined number of supplement beams have been selected to allocate resources.

17. The method of claim 11 wherein the number of supplement beams included in the at least a portion of the one or more supplement beams is less than or equal to the number of beams included in the first set of beams, or
when the number of supplement beams included in the at least a portion of the one or more supplement beams is larger than the number of beams included in the first set of beams, the at least a portion of the one or more supplement beams is divided into supplement beam groups including a number of supplement beams less than or equal to the number of beams included in the first set of beams, and the supplement beam groups are swept at different timing.

18. The method of claim 11 wherein the first set of beams and the at least a portion of the one or more supplement beams are swept at an interval of a first period with a time difference between the sweeping of the first set of beams and the sweeping of the at least a portion of the one or more supplement beams, and the one or more supplement beams are determined at an interval of a second period longer than or equal to the first period.

19. A beam selection method comprising:
receiving a first resource allocation for a first set of beams;
measuring the first set of beams based on the first resource allocation;
receiving a second resource allocation for a supplement beam different from the first set of beams; and
measuring the supplement beam at a timing different from the timing of measuring the first set of beams, based on the second resource allocation.

20. The method of claim 19 wherein the first set of beams and the supplement beam are measured at a first period with a time difference between measurement of the first set of beams and measurement of the supplement beam, and the second resource allocation is received at a second period longer than or equal to the first period.

21-30. (canceled)

31. A non-transitory computer readable medium comprising instructions, when executed by at least one processor in a network device, cause the network device to at least perform:
sweeping a first set of beams, the first set of beams being predefined for a cell;
determining one or more supplement beams for one or more user equipments in the cell, the one or more supplement beams being selected from a second set of beams different from the first set of beams; and
sweeping at least a portion of the one or more supplement beams.

32. A non-transitory computer readable medium comprising instructions, when executed by at least one processor in a terminal device, cause the terminal device to at least perform:
receiving a first resource allocation for a first set of beams;
measuring the first set of beams based on the first resource allocation;
receiving a second resource allocation for a supplement beam different from the first set of beams; and
measuring the supplement beam at a timing different from the timing of measuring the first set of beams, based on the second resource allocation.
